(19) United States
(12) Patent Application Publication
(10) Pub. No.: US 2021/0230801 A1
(43) Pub. Date: Jul. 29, 2021

(54) ARRANGEMENT AND SYSTEM FOR A TREATMENT PROCESS

(71) Applicant: VALMET AB, Sundsvall (SE)

(72) Inventors: Francois LAMBERT, Sundsvall (SE); Robert WAHLBERG, Sundsvall (SE); Patrik PETTERSSON, Alnö (SE)

(73) Assignee: VALMET AB, Sundsvall (SE)

(21) Appl. No.: 17/216,850

(22) Filed: Mar. 30, 2021

Related U.S. Application Data
(63) Continuation-in-part of application No. PCT/SE2019/050744, filed on Aug. 13, 2019.

(30) Foreign Application Priority Data
Oct. 1, 2018 (SE) 1851176-6

(51) Int. Cl. D21C 7/06; D21B 1/02

(52) U.S. Cl. CPC D21C 7/06; D21B 1/02

(57) ABSTRACT

A system for feeding lignocellulosic biomass material, comprising a pre-compressing stage for receiving biomass material and pre-compressing the material at a first pressure and a first compression ratio. A plug screw feeder receives the pre-compressed material and feeds the material against a second pressure and a second compression ratio, wherein the plug screw feeder includes a variable speed plug screw arranged in the plug screw feeder connected to a variable speed plug screw power source.

### TECHNICAL FIELD

The present invention relates to treatment of lignocellulosic material in processes, such as in a hydrolysis process, and more specifically to methods and arrangements for feeding material with low or no network strength such as powder like material, steam exploded material and high density granular material.

### BACKGROUND OF THE INVENTION

Lignocellulosic biomass is abundant and can provide a sustainable resource for producing fuels, chemicals and biobased materials. For example, biomass can be used in pulping processes or as an important resource in producing sustainable and renewable bio-fuels and for reducing the carbon footprint. Accordingly, it is important to develop efficient systems for handling biomass material in processes for producing, for example, pulp and bio-fuels. One problem in feeding arrangements for feeding biomass material is related to feeding of powder like material and granular like material with high bulk density and low network strength. Traditionally, a plug screw is used for feeding material against pressure. A plug screw feeder is working on the following principles. The material is compressed by a decrease of the volume when it is transported forward. (Air and water can be removed during this step). The volumetric compression is dependent on the geometry of the screw. At the end of the volumetric compression, the material is transferred to a plug pipe which is placed between the volumetric compression part and the vessel to be fed (e.g pressurized reactor, impregnator, refiner). The wall friction lead to further compression. At the end of the plug pipe, a retaining member (blow back damper) is pushing against the material. It both increases the compression and break the plug so that the material falls in the following vessel. It can even have a safety function (closing the inlet in case no plug is formed to avoid pressure release through the reactor). In the volumetric compression zone of the plug screw, anti-rotation bars are used to avoid that the material will rotate with the screw i.e. it forces the material to move forward. Anti-rotation bar can also be used in the plug pipe. Anti-rotation bar could have several designs and be straight or curved or spirals for example. The physical principles behind this feeding is that the material elements are “hooked” to each other. I.e. the material has a certain network strength that makes it possible to form a network that can be compressed without the network being disrupted when a certain shear force is applied.

In some applications, a second screw is used to force feed the plug screw feeder. It is used with bulky materials such as annual plant like straw. These materials are much more bulky than wood and it is difficult to reach high compression in a plug screw feeder (or a bigger and more expensive plug screw feeder should be used). The force feed screw leads to a pre-compression of the bulky material and it is then much easier to compress further this material in the plug screw feeder, i.e. create a network that can resist the shear forces in the plug screw. For example, wheat straw could be pre-compressed from 45 to 120-160 kg/m³, which is a compression ratio of about 3:1-4:1. The pre-compression that is created with a force feed screw does not occurs in the screw itself. Even if some force feed screws could have a geometry that is designed to give a compression in the screw, the principle of force feeding is based on an interaction between the force feed screw and the plug screw as described below. The force feed screw transports the material and force feed it in the plug screw. The plug screw feeder is rotating at a certain rpm corresponding to a certain volume of revolution at its inlet. Through force feeding of a volume of material from the force feed screw to the plug screw feeder which is bigger than what the volume of revolution of the plug screw feeder are (at its inlet), it is possible to obtain a compression. This compression is not dependent on the geometry of the force feed screw but on the interaction between the force feed screw and the plug screw. Force feed screws are used with bulky material in order to obtain a higher bulk density (and thereby a higher network strength). Though it is possible to use it with wood chips, it will not give any advantage for the feeding. In some applications, force feed screws are used to create a higher compression with wood in order to create cracks in woody material. The compression ratio when feeding bulky material could be 2:1-3:1 up to 6 times the bulk density when entering into the plug screw.

Feeding of material with poor or low network strength is often problematic since the material elements does not get “hooked” to each other. For example, straw has a very good network strength when it is compressed to wood chip density. But small particles of wood chips, powder like material, or steam exploded material have low network strength. Rod like or straw like material are more inclined to form a network and stick to each other whereas small cubes or sphere will just fall apart. This is even more pronounced when the material is hard, has a high density, and thereby is difficult to compress.

When feeding a material with low network strength, the material tries to form a plug but the action of the anti-rotation bars in the plug screw breaks the material plug as it has too low network strength to withstand the shear force applied. The material fills the space between the anti-rotation bars, and thereby the anti-rotation bars will not have any anti-rotational effect. Instead, the material starts to rotate with the screw and is not fed or transferred forward. I.e. the plug formed by the volumetric compression is too weak and destroyed by the shear force.

Thus, there is a need in the industry for improved systems and methods for feeding biomass material and, in particular, granular like biomass material such as wood chips, powder like material, or steam exploded material with high bulk density and low network strength.

### SUMMARY OF THE INVENTION

According to an object of the present invention, there is provided improved systems and methods for feeding biomass material and in particular, for feeding granular like biomass material such as sawdust, powder like material, or steam exploded material with high bulk density and low network strength.

According to another object of the present invention, there is provided improved systems and methods using less energy to feed a given amount of biomass material in particular, for feeding granular like biomass material such as sawdust, powder like material, or steam exploded material with high bulk density and low network strength.

These and other objects are achieved in accordance with the appended claims.

In the context of the present invention, the term “plug screw feeder” relates to a feeder comprising a screw or similar rotating means and which is capable of feeding or transporting lignocellulosic material through the feeder at increased or maintained density of the material and that creates an essentially gas- and fluid-tight plug of the lignocellulosic material towards the end of the feeder. For example, according to an embodiment of such a plug screw feeder, a cross-sectional area of the circular housing of the feeder and the screw diameter decreases in the feeding direction thereby so as to create a decreasing space between the screw and the housing and thus resulting in an essentially gas- and fluid-tight plug of the lignocellulosic material towards the end of the feeder. According to another embodiment of a plug screw feeder, the cross-sectional area of the circular housing of the feeder is constant while and the screw diameter and screw axis increases in the feeding direction thereby creating a decreasing space between the screw and the housing and thus resulting in an essentially gas- and fluid-tight plug of the lignocellulosic material towards the end of the feeder. As the skilled person realizes, there are other embodiments of feeders that achieves this purpose and thus are included within the definition of the term “plug screw feeder”.

Further, in the context of the present invention, the term “network strength” of a certain material relates to the phenomena when material elements are “hooked” to each other thereby creating a network or mat. The material can be compressed without the network being disrupted when a certain shear force is applied. This network strength can be explained by a power function, Tauyield=A*Cm\hat{ }B, where A and B are material constants that can be determined experimentally and differs between different material. Cm is the density or bulk density, which relates to the total density of a given volume material including possible liquids and/or air. Thereby, a compressed material will have a higher density even if the density of material itself is the same for a given Cm. Hence, the Tauyield will increase with increased density. Constants A and B are related to the length of the material elements such that an increased length implies higher A and B constants. Thus, a material such as straw will have a higher network strength when composed of longer individual straw elements. On the other end, a powder like or granular material will have a low network strength. The network strength is measured in Pascal “Pa”.

Further, in the context of the present invention, the term “pressure lock” refers to a pressure proof barrier allowing different pressures on respective sides of the barrier.

Moreover, in the context of the present invention, the term “bulk density” refers to a property of powders, granules, and other “divided” solids, especially used in reference to mineral components (soil, gravel), granular like or powder like biomass materials, or any other masses of corpuscular or particulate matter. It is defined as the mass of many particles of the material divided by the total volume they occupy. The total volume includes particle volume, inter-particle void volume, and internal pore volume. Bulk density is not an intrinsic property of a material; it can change depending on how the material is handled. For example, a powder poured into a cylinder will have a particular bulk density; if the cylinder is disturbed, the powder particles will move and usually settle closer together, resulting in a higher bulk density. For this reason, the bulk density of powders is usually reported both as “freely settled” (or “poured” density) and “tapped” density (where the tapped density refers to the bulk density of the powder after a specified compaction process, usually involving vibration of the container.). For example, the bulk density of soil depends greatly on the mineral make up of soil and the degree of compaction. The density of quartz is around 2.65 g/cm³ but the (dry) bulk density of a mineral soil is normally about half that density, between 1.0 and 1.6 g/cm³. Soils high in organics and some friable clay may have a bulk density well below 1 g/cm³. The reason why soils rich in soil organic carbon do have lower bulk density is due to the low density of organic materials. For instance peat soils have bulk densities of around 0.02 Mg m-3. There is two measures of bulk density: dry bulk density and wet bulk density. The dry and wet bulk densities are calculated as: dry bulk density=mass of substance/volume as a whole and wet bulk density=mass of substance plus liquids/volume as a whole. In the present application, the term “bulk density” will refer to dry bulk density.

In the context of the present invention, the terms “compression ratio” or “density compression ratio” refers to a density change or a difference between two densities of a material. Further, the term “volumetric compression ratio” refers to a change of volume in, for example, an apparatus.

According to an aspect of the present invention, there is provided a system for feeding lignocellulosic biomass material, comprising a pre-compressing stage for receiving biomass material and pre-compressing the material at a first pressure and a first volumetric compression ratio. A plug screw feeder receives the pre-compressed material and feeds the material against a second pressure and a second volumetric compression ratio, wherein the plug screw feeder includes a variable speed plug screw arranged in the plug screw feeder connected to a variable speed plug screw power source. The first volumetric compression ratio in the pre-compression stage is configured to produce a first density compression ratio between over 1:1 (>1) and below 2:1 (<2) and the second volumetric compression ratio in the plug screw feeder is configured to produce a second density compression ratio between 1-5, or 1:1-5:1, or >1:1-5:1, or 1.001:1-5:1, or 1.01:1-5:1, or 1.1:1-5:1. Hence, the plug screw feeder of the first compression stage or pre-compression stage is arranged with a cross-sectional area of the circular housing of the feeder and the screw diameter that decreases in the feeding direction such that a density compression ratio of over 1:1 (>1) and below 2:1 (<2) is produced towards the end of the feeder. The plug screw feeder of the pre-compression stage may alternatively be arranged with a cross-sectional area of the circular housing of the feeder that is constant while and the screw diameter and screw axis increases in the feeding direction thereby creating a decreasing space between the screw and the housing and thus resulting in that a density compression ratio of over 1:1 (>1) and below 2:1 (<2) is produced towards the end of the feeder. Further, in the second compression stage a force feed screw or plug-screw feeder may be used. The force feed screw may be adapted or configured to produce a density compression ratio of the material between 1-5, or 1:1-5:1, or >1:1-5:1, or 1.001:1-5:1, or 1.01:1-5:1, or 1.1:1-5:1. A plug-screw feeder may be arranged with a cross-sectional area of the circular housing of the feeder and the screw diameter that decreases in the feeding direction such that a density compression ratio of between 1-5, or 1:1-5:1, or >1:1-5:1, or 1.001:1-5:1, or 1.01:1-5:1, or 1.1:1-5:1 is produced towards the end of the feeder, or alternatively the plug-screw feeder may be arranged with a cross-sectional area of the circular housing of the feeder that is constant while and the screw diameter and screw axis increases in the feeding direction thereby creating a decreasing space between the screw and the housing and thus resulting in that a density compression ratio of between 1-5, or 1:1-5:1, or >1:1-5:1, or 1.001:1-5:1, or 1.01:1-5:1, or 1.1:1-5:1 is produced towards the end of the feeder.

According to another aspect of the present invention, there is provided a method for feeding lignocellulosic biomass material, comprising: pre-compressing biomass material at a first pressure and a first compression ratio in a pre-compression stage, and applying a second pressure on receiving the pre-compressed material and feeding the material against a second pressure in a second pressure applying stage at a second compression ratio. The first compression ratio in the pre-compression stage (2) is between compression ratio over 1:1 (>1) and below 2:1 (<2) and the second compression ratio in the plug screw feeder (6) is between 1-5 or 1:1-5:1, or >1:1-5:1, or 1.001:1-5:1, or 1.01:1-5:1, or 1.1:1-5:1.

The present invention is based on the surprising insight that biomass material with high bulk density and low network strength can be feed in a plug screw feeder when the material is pre-compressed before entering the plug screw feeder and low compression is used in the plug screw feeder. This is in fact completely contravenes the prior understanding and practice within the business. Traditionally, materials with low bulk density and high network strength have been handled in this manner. Thus, the present invention is based on moving a part of the compression from the plug screw feeder to the pre-compression stage, preferably a force feed screw, in order to increase density and though network strength of the material going in the plug screw feeder. A goal of the invention is to increase the compression before the plug screw feeder and consequently increase Tauyield. The force feed screw is used to pre-compress the material with a non-volumetric compression method (i.e. the geometry of the screw is not the compressing factor). The plug screw feeder could then be used with less compression to form a plug. Less energy will be used in the plug screw to compress the material and form the plug which means that the plug will be formed in a more “kind” way that without pre-compression. With pre-compression, the material will withstand more shear force against the anti-rotation bar, which will significantly decrease the risk for breaking the plug against the anti-compression bar.

The biomass material includes, for example, wood-based raw materials such as sawdust, chipped or hammer-milled forest residuals, agricultural residues such as bagasse, sugar cane straw, wheat straw, corn stover, corn cobs, oil palm fruit residuals (so-called empty fruit bunches). Other types of lignocellulosic biomass material that can be used in accordance with the present invention include grasses, reeds and energy canes.

In embodiments of the present invention, the pre-compression stage is a force feed screw including a force feed cylinder and a variable speed force feed screw arranged in the force feed cylinder, wherein a control arrangement controls the speed of the rotation of the variable speed force feed screw to a first RPM.

In embodiments of the present invention, the control arrangement controls the speed of the rotation of the variable speed plug screw to a second RPM.

In embodiments of the present invention, the

force feed screw is configured or arranged to produce a density compression ratio in a range between over 1:1 (>1) and below 2:1 (<2), or in a range between 1:1-1.5:1 or >1:1-1.5:1, or 1.001:1-1.5:1, or 1.01:1-1.5:1, or 1.1:1-1.5:1, or preferably in a range between 1.05-1.4 (1.05:1-1.4:1).

In embodiments of the present invention, the

plug screw feeder is arranged or configured to produce a density compression ratio in a range of 1:1-5:1, or 1.001:1-5:1, or 1.01:1-5:1, or 1.1:1-5:1. or in a range between 1:1-4.5:1, or 1.001:1-4.5:1, or 1.01:1-4.5:1, or 1.1:1-4.5:1, or in a range between 2-4.5, or 2.001:1-4.5:1, or 2.01:1-4.5:1, or 2.1:1-4.5:1. or in a range of 3-4,5 or 3.001:1-4.5:1, or 3.01:1-4.5:1, or 3.1:1-4.5:1, or in a range between 1-2,5, or 1.001:1-2.5:1, or 1.01:1-2.5:1, or 1.1:1-2.5:1, or substantially equal to 1.

In embodiments of the present invention, a bulk density of biomass material entering the force feed screw is in a range of 110-200 kg/m³ or in a range between 120-150 kg/m³.

In embodiments of the present invention, the biomass material is powder material, granular material and/or steam exploded material.

In embodiments of the present invention, the system is used in a pulping process. As discussed above, the present invention provides advantages over the prior art technologies. Additional advantages of the present invention will be understood from the detailed description.

### BRIEF DESCRIPTION OF THE DRAWINGS

The present invention will now be described, for exemplary purposes, in more detail by way of embodiments and with reference to the enclosed drawings, in which:

FIG. 1 is a schematic view of a feeding system according to an embodiment of the present invention; and

FIG. 2 is a schematic view of a method for feeding according to an embodiment of the present invention.

### DETAILED DESCRIPTION OF PREFERRED EMBODIMENTS

For the purpose of this disclosure, the term longitudinal refers to the direction along which a body, part or element has its greatest extension. Further, when the term longitudinal is used in connection with the axes of screws, the longitudinal axis corresponds to the rotational axis of the screw.

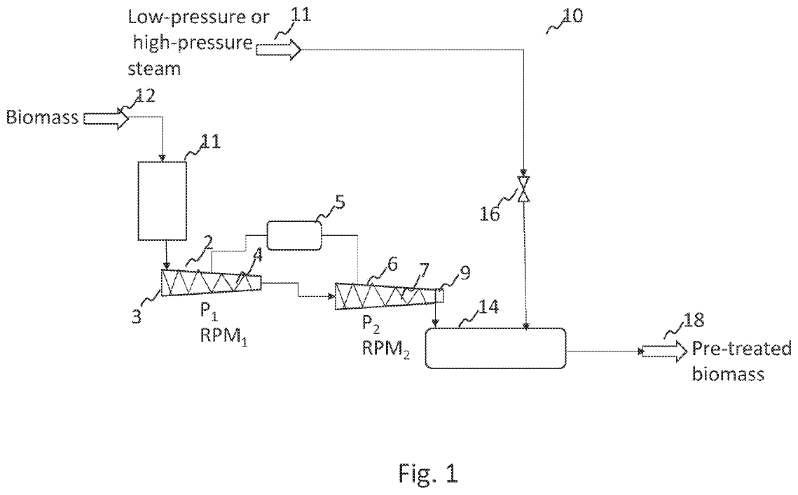

With reference first to FIG. 1, an embodiment of the system according to the present invention will be discussed.

FIG. 1 is a schematic block diagram of a system 10 for biomass treatment according to an embodiment of the present invention. The lignocellulosic biomass 12 may be treated in different processes, such as a soaking process, before feeding the biomass material to the storage vessel, bin or silo 11. The biomass material may be, for example, granular like biomass material such as wood chips, powder like material, or steam exploded material with high bulk density and low network strength based on wood chips of softwood or hardwood, sawdust, grasses, straw, bagasse, kenaf, or other forms of agricultural waste or a combination thereof.

A pre-compression stage 2 receives the biomass material and executes a pre-compression by applying a first pressure P₁. In preferred embodiments, the pre-compression stage is a longitudinally arranged force feed screw 2. The force feed screw 2 includes a force feed cylinder 3 and a variable speed force feed screw 4 arranged in the force feed cylinder 3. A control arrangement 5 controls the speed of the rotation of the variable speed force feed screw 2 to a first RPM, RPM₁. In other embodiments of the present invention, the pre-compression stage includes one or several plug screws with low compression degree, a vertical chute or a piston feeding.

The force feed screw 2 is operatively connected to a longitudinally arranged plug screw feeder 6 for receiving the pre-compressed biomass material and feeding the material against a second pressure P₂. The plug screw feeder 6 includes a variable speed plug screw 7 arranged in the plug screw feeder 6 and is connected to the control arrangement including a variable speed plug screw power source, and wherein the control arrangement 5 controls the speed of the rotation of the variable speed plug screw 7 to a second RPM, RPM₂. The plug screw feeder 6 also includes a blow back damper 9.

A first density compression ratio produced by the force feed screw is in a range between 1:1 (>1) and below 2:1 (<2), or in a range between 1:1-1.5:1 or >1:1-1.5:1, or 1.001:1-1.5:1, or 1.01:1-1.5:1, or 1.1:1-1.5:1, or preferably in a range between 1.05-1.4 (1.05:1-1.4:1), and a second density compression ratio produced by the plug screw feeder is in a range of 1:1-5:1, or 1.001:1-5:1, or 1.01:1-5:1, or 1.1:1-5:1. or in a range between 1:1-4.5:1, or 1.001:1-4.5:1, or 1.01:1-4.5:1, or 1.1:1-4.5:1, or in a range between 2-4.5, or 2.001:1-4.5:1, or 2.01:1-4.5:1, or 2.1:1-4.5:1. or in a range of 3-4,5 or 3.001:1-4.5:1, or 3.01:1-4.5:1, or 3.1:1-4.5:1, or in a range between 1-2,5, or 1.001:1-2.5:1, or 1.01:1-2.5:1, or 1.1:1-2.5:1, or substantially equal to 1.

A bulk density of the biomass material entering the force feed screw 2 is in a range of 110-200 kg/m³ or in a range between 120-150 kg/m³.

The system according to the present invention may be used in a pulping process or a process for producing bio-fuels.

The plug screw feeder 6 may further be operatively connected to downstream processing steps 14 such as, for example, a reactor stage 14 wherein steam 11, e.g. high pressure steam at a pressure of about 650-4000 kPa or low-pressure steam at a pressure of about 90-1200 kPa, may be added via a valve 16.

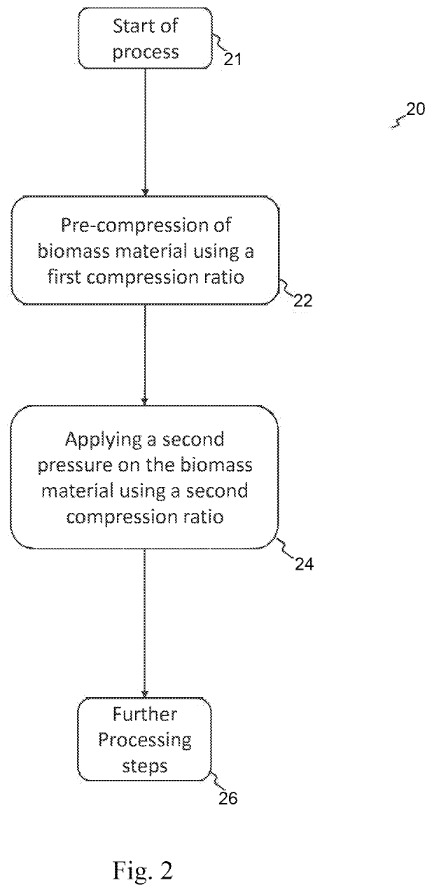

FIG. 2 is a schematic block diagram of a method 20 for biomass treatment according to an embodiment of the present invention. The lignocellulosic biomass 12 may be treated in different processes, such as a soaking process, before feeding the biomass material to the storage vessel, bin or silo. The biomass material may be, for example, granular like biomass material such as wood chips, powder like material, or steam exploded material with high bulk density and low network strength based on wood chips of softwood or hardwood, sawdust, grasses, straw, bagasse, kenaf, or other forms of agricultural waste or a combination thereof.

First, a pre-compression 22 is performed using a pre-compression stage 2 by applying a first pressure P₁ and a first compression ratio. In preferred embodiments, the pre-compression stage is a longitudinally arranged force feed screw 2.

Then, a second pressure applying step 24 is performed using a longitudinally arranged plug screw feeder 6 for receiving the pre-compressed biomass material and feeding the material against a second pressure P₂ and a second compression ratio.

The first compression ratio in the pre-compression step 22 may, depending on the specific material used, be higher, lower or substantially equal to the second compression ratio in the second pressure applying step 24. A first compression ratio in the force feed screw is in a range between 1:1 (>1) and below 2:1 (<2), or in a range between 1:1-1.5:1 or >1:1-1.5:1, or 1.001:1-1.5:1, or 1.01:1-1.5:1, or 1.1:1-1.5:1, or preferably in a range between 1.05-1.4 (1.05:1-1.4:1), and a second compression ratio in the plug screw feeder is in a range of 1:1-5:1, or 1.001:1-5:1, or 1.01:1-5:1, or 1.1:1-5:1. or in a range between 1:1-4.5:1, or 1.001:1-4.5:1, or 1.01:1-4.5:1, or 1.1:1-4.5:1, or in a range between 2-4.5, or 2.001:1-4.5:1, or 2.01:1-4.5:1, or 2.1:1-4.5:1, or in a range of 3-4,5 or 3.001:1-4.5:1, or 3.01:1-4.5:1, or 3.1:1-4.5:1, or in a range between 1-2,5, or 1.001:1-2.5:1, or 1.01:1-2.5:1, or 1.1:1-2.5:1, or substantially equal to 1.

A bulk density of the biomass material entering the pre-compression step 22 is in a range of 110-200 kg/m³ or in a range between 120-150 kg/m³.

The method according to the present invention may be used in a pulping process or a process for producing bio-fuels.

The second pressure applying step 24 may feed the biomass material downstream processing steps 26 such as, for example, a reactor stage 14 wherein steam 11, e.g. high pressure steam at a pressure of about 650-4000 kPa or low-pressure steam at a pressure of about 90-1200 kPa, may be added.

The invention shall not be considered limited to the embodiments illustrated, but can be modified and altered in many ways by one skilled in the art, without departing from the scope of the appended claims.

1. A system for feeding lignocellulosic biomass material, comprising:
a pre-compressing stage for receiving biomass material and pre-compressing the material at a first pressure and a first compression ratio;
a plug screw feeder for receiving the pre-compressed material and feeding the material against a second pressure and a second compression ratio, said plug screw feeder including a variable speed plug screw arranged in the plug screw feeder connected to a variable speed plug screw power source; and
wherein the first compression ratio in the pre-compression stage is between >1 and <2 and the second compression ratio in the plug screw feeder is between 1-5.

2. The system according to claim 1, wherein the pre-compression stage is a force feed screw including a force feed cylinder and a variable speed force feed screw arranged in the force feed cylinder, wherein a control arrangement controls the speed of the rotation of the variable speed force feed screw to a first RPM.

3. The system according to claim 2, wherein said control arrangement controls the speed of the rotation of the variable speed plug screw to a second RPM.

4. The system according to claim 2, wherein the first compression ratio in the force feed screw is in a range between >1 and <2, or in a range between 1-1.5 or preferably in a range between 1.05-1.4.

5. The system according to claim 1, wherein the second compression ratio in the plug screw feeder is in a range of 1-5, or in a range between 3-4, 5 or in a range between 1-2,5, or substantially equal to 1.

6. The system according to claim 2, wherein a bulk density of biomass material entering the force feed screw is in a range of 110-200 kg/m³ or in a range between 120-150 kg/m³.

7. The system according to claim 1, wherein the biomass material is powder material, granular material and/or steam exploded material.

8. The system according to claim 1, where the system is used in a pulping process.

9. A method for feeding lignocellulosic biomass material, comprising:
pre-compressing biomass material at a first pressure and a first compression ratio in a pre-compression stage;
applying a second pressure on receiving the pre-compressed material and feeding the material against a second pressure and a second compression ratio in a second pressure applying stage, and
wherein the first compression ratio in the pre-compression stage is between >1 and <2 and the second compression ratio in lower the plug screw feeder is between 1-5.

10. The method according to claim 9, wherein the first compression ratio in the pre-compression stage is in a range between >1 and <2, or in a range between 1-1.5 or preferably in a range between 1.05-1.4.

11. The method according to claim 9, wherein the second compression ratio in the second pressure applying stage is in a range between 1-5, or in a range between 3-4, 5 or in a range between 1-2, 5, or substantially equal to 1.

12. The method according to claim 9, wherein a bulk density of biomass material entering the pre-compression stage is in a range of 110-200 kg/m³ or in a range between 120-150 kg/m³.

13. The method according to claim 9, wherein the biomass material is powder material, granular material and/or steam exploded material.

14. The system according to claim 9, wherein the method is used in a pulping process.
